(19) United States
(12) Patent Application Publication
(10) Pub. No.: US 2018/0189547 A1
(43) Pub. Date: Jul. 5, 2018

(54) BIOMETRIC IDENTIFICATION SYSTEM

(71) Applicant: Intel Corporation, Santa Clara, CA (US)

(72) Inventors: Melanie Daniels, Folsom, CA (US); Laura L. Warner, Folsom, CA (US); Peter D. Mueller, Fair Oaks, CA (US)

(73) Assignee: Intel Corporation, Santa Clara, CA (US)

(21) Appl. No.: 15/396,053

(22) Filed: Dec. 30, 2016

(51) Int. Cl. G06K 9/00; H04N 5/33

(52) U.S. Cl. CPC G06K 9/00228; H04N 5/33; G06K 9/00617; G06K 9/00288

(57) ABSTRACT

Technology for a biometric identification system is described. The biometric identification system can include an infrared (IR) illumination device, a thermal imager, and a controller. The controller can determine, using a defined thermal profile, when a thermal image captured by the thermal imager includes a face of a user. The controller can determine, based on the thermal image, when the face of the user is located within a selected range of distances from the thermal imager. The controller can instruct the IR illumination device to illuminate for a selected period of time when the face of the user is located within the selected range of distances from the thermal imager.

### BACKGROUND

A biometric system can utilize biometric identifiers to identify and/or authenticate users. Biometric identifiers can be distinctive and measurable characteristics that are used to label and describe users. Biometric identifiers can be physiological identifiers or behavioral identifiers. Non-limiting examples of physiological identifiers can include fingerprints facial characteristics, deoxyribonucleic acid (DNA), iris characteristics, retina characteristics, odors, etc. Non-limiting examples of behavioral identifiers can include voice, gait, etc.

In one example, biometric identifiers for a specific user can be stored in a database. At a later time, a certain biometric (e.g., eye scan) can be captured for the user for purposes of identification and/or authentication. The biometric captured for the user can be compared with biometric identifiers stored for the user in the database. When there is a match between the biometric (e.g., eye scan) that is captured and the biometric identifiers stored for the user in the database, the user can be identified and/or authenticated.

### BRIEF DESCRIPTION OF THE DRAWINGS

Features and advantages of invention embodiments will be apparent from the detailed description which follows, taken in conjunction with the accompanying drawings, which together illustrate, by way of example, invention features; and, wherein:

FIG. 1 illustrates a biometric identification system for identifying a user's biometrics in accordance with an example embodiment;

FIG. 2 depicts a flowchart of a method for identifying a user's biometrics in accordance with an example embodiment; and

FIG. 3 illustrates a computing system that includes a data storage device in accordance with an example embodiment.

Reference will now be made to the exemplary embodiments illustrated, and specific language will be used herein to describe the same. It will nevertheless be understood that no limitation on invention scope is thereby intended.

### DESCRIPTION OF EMBODIMENTS

Before the disclosed invention embodiments are described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular examples or embodiments only and is not intended to be limiting. The same reference numerals in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, network examples, etc., to provide a thorough understanding of various invention embodiments. One skilled in the relevant art will recognize, however, that such detailed embodiments do not limit the overall inventive concepts articulated herein, but are merely representative thereof.

As used in this written description, the singular forms “a,” “an” and “the” include express support for plural referents unless the context clearly dictates otherwise. Thus, for example, reference to “an imager” includes a plurality of such imagers.

Reference throughout this specification to “an example” means that a particular feature, structure, or characteristic described in connection with the example is included in at least one embodiment of the present invention. Thus, appearances of the phrases “in an example” or “an embodiment” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention can be referred to herein along with alternatives for the various components thereof. It is understood that such embodiments, examples, and alternatives are not to be construed as defacto equivalents of one another, but are to be considered as separate and autonomous representations under the present disclosure.

Furthermore, the described features, structures, or characteristics can be combined in any suitable manner in one or more embodiments. In the following description, numerous specific details are provided, such as examples of layouts, distances, network examples, etc., to provide a thorough understanding of invention embodiments. One skilled in the relevant art will recognize, however, that the technology can be practiced without one or more of the specific details, or with other methods, components, layouts, etc. In other instances, well-known structures, materials, or operations may not be shown or described in detail to avoid obscuring aspects of the disclosure.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith.

For example, trace elements present in a composition, but not affecting the compositions nature or characteristics would be permissible if present under the “consisting essentially of” language, even though not expressly recited in a list of items following such terminology. When using an open ended term in this written description, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, comparative terms such as “increased,” “decreased,” “better,” “worse,” “higher,” “lower,” “enhanced,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art. For example, an electronic device that has an “increased” risk of unauthorized use (e.g. because of proximity or location) can refer to a device that is used in a public area or space, as compared to a device that is used in an area or space with limited access, or that is secured by some mechanism. A number of factors can cause such increased risk, including location, fabrication process, number of program pulses applied to the region, etc.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

Numerical amounts and data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

### Example Embodiments

An initial overview of technology embodiments is provided below and then specific technology embodiments are described in further detail later. This initial summary is intended to aid readers in understanding the technology more quickly, but is not intended to identify key or essential technological features nor is it intended to limit the scope of the claimed subject matter. Unless defined otherwise, all technical and scientific terms used herein have the same meaning as commonly understood by one of ordinary skill in the art to which this disclosure belongs.

A biometric system can utilize biometric identifiers to identify and/or authenticate users. One example of a biometric system is an iris recognition system. The iris recognition system is an ocular-based biometric technology that uses images of one or both of the irises of the user's eyes. Irises can have complex random patterns that are unique and stable. In one example, the iris recognition system can capture an image of the user's iris (or irises) using a camera. The iris recognition system can maintain a database of images that depict a plurality of users' irises. The iris recognition system can compare the captured image of the user to the images stored in the database. When there is a match between the captured image for the user and a given image stored in the database (i.e., the patterns in the captured image are substantially similar to the patterns in the given image), the user can be identified and/or authenticated. In other words, the user can be identified and/or authenticated since an image of the user's iris (or irises) is already stored in the database.

In one example, the camera in the iris recognition system can acquire images of the iris when the iris is illuminated by a light, such as a light emitting diode (LED) or laser, in a near infrared wavelength band of the electromagnetic spectrum. The near infrared wavelength band can range from 700-900 nanometers (nm). Thus, the iris recognition system can use camera technology with subtle near infrared illumination in order to acquire images of the intricate structure of the user's iris.

Another example of a biometric system is retinal scanning, which is an ocular-based biometric technology that uses the unique patterns on the use's retina blood vessels. A retina scan can be performed by casting a beam of low-energy infrared light into the user's eye. The beam of low-energy infrared light can trace a standardized path in the user's retina. Retinal blood vessels can absorb light more readily than surrounding tissue, so an amount of reflection can vary during the retinal scan. A pattern of variations can be digitized and stored as a retinal scan image. Similar to the iris recognition system, a captured retinal scan image of a user can be compared with a plurality of retinal scan images stored in a database. When there is a match between the captured retinal scan image for the user and a given retinal scan image stored in the database (i.e., the variation patterns in the captured retinal scan image are substantially similar to the variation patterns in the given retinal scan image), the user can be identified and/or authenticated.

Iris recognition and retinal scanning can both utilize non-ionizing radiation in the infrared region. For example, both iris recognition and retinal scanning can involve illumination of the user's eye using infrared illumination devices, such as infrared LEDs or infrared lasers. Although the illumination devices are likely to emit incoherent light, there is a growing concern that the illumination devices can pose a potential threat since exposure to intense coherent infrared radiation can have significant effects on living tissues. Therefore, it is desirable to minimize the user's exposure to radiation when iris recognition or retinal scanning is being performed.

As described in further detail below, the present technology encompasses a biometric identification system that includes an infrared (IR) illumination device, a thermal imager, and a controller. The controller can obtain a thermal image captured by the thermal imager. The controller can determine, using a defined thermal profile, when the thermal image captured by the thermal imager includes a face of a user. The controller can determine, based on the thermal image, when the face of the user is located within a selected range of distances from the thermal imager. The controller can instruct the IR illumination device to illuminate for a selected period of time when the face of the user is located within the selected range of distances from the thermal imager, and the IR illumination device can be illuminated to enable a biometric identification to be performed for the user. By restricting the IR illumination device to be illuminated only when the face of the user is located within the selected range of distances from the thermal imager, the user's exposure to radiation from the IR illumination device can be minimized.

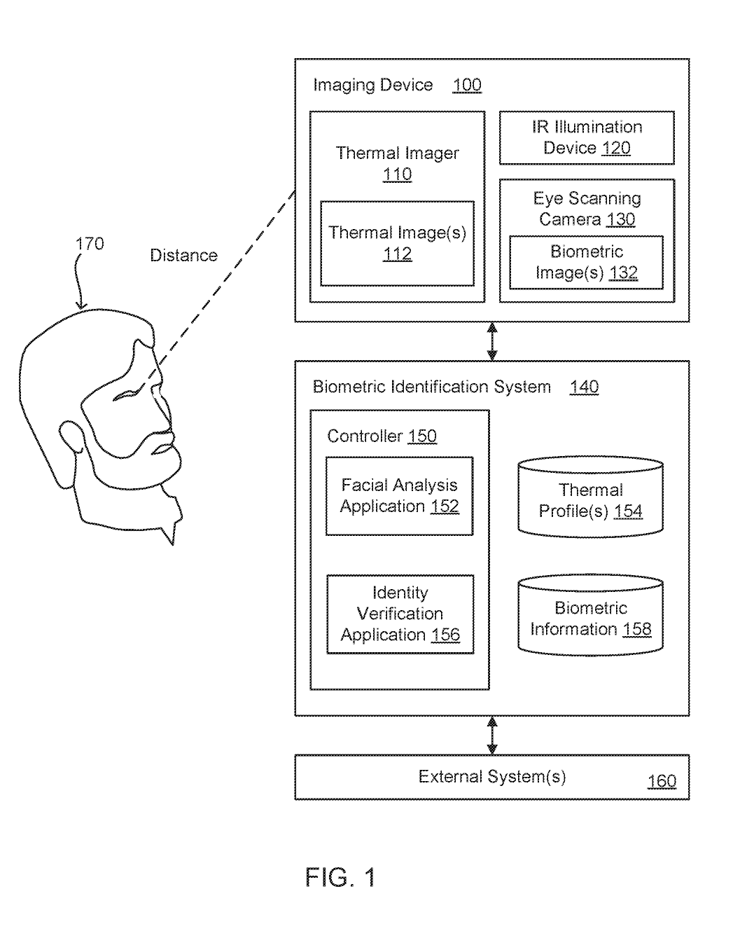

FIG. 1 illustrates an exemplary biometric identification system 140 for identifying biometrics of a user 170. The biometric identification system 140 can include or be communicatively coupled to an imaging device 100. The imaging device 100 can include a thermal imager 110, an infrared (IR) illumination device 120 and an eye scanning camera 130. Alternatively, the thermal imager 110, the IR illumination device 120 and the eye scanning camera 130 can be separate devices that are capable of communicating with the biometric identification system 140. The IR illumination device 120 can include an IR light emitting diode (LED) or an IR laser.

In one example, the thermal imager 110 can capture a thermal image 112 of the user 170. The thermal imager 110 can detect radiation emitted by an object in the long-infrared range of the electromagnetic spectrum (which is roughly 9000 to 14,000 nanometers), and the thermal imager 110 can produce thermal images 112 of that radiation. The thermal imager 110 can detect radiation emitted by the object in the short-wavelength infrared (SWIR), mid-wavelength infrared (MWIR) or long-wavelength infrared (LWIR) region of the infrared spectrum. An object with a temperature higher than absolute zero can emit radiation, and the amount of radiation emitted by the object can depend on a temperature and emissivity of the object. For example, the amount of radiation emitted by the object can increase when the temperature of the object increases. Therefore, warm objects, such as human users, can be visible against the environment, day or night. Human users can be well detected by the thermal imager 110, even in cold conditions and when the user wears glasses. In one example, when the user 170 is positioned in front of the thermal imager 110, the thermal imager 110 can capture the thermal image 112 of the user 170.

In one example, the thermal imager 110 can provide the thermal image 112 captured of the user 170 to a controller 150 in the biometric identification system 140. The controller 150 can receive the thermal image 112 of the user 170 from the thermal imager 110. The controller 150 can use a facial analysis application 152 that executes on the biometric identification system 140 to determine, based on a defined thermal profile 154, when the thermal image 112 includes a face of a human user. The defined thermal profile 154 can be specific to live human users, as opposed to other objects and animals. In other words, the controller 150 can compare the thermal image 112 with the defined thermal profile 154 using the facial analysis application 152, and based on the comparison, the controller 150 can determine that the thermal image 112 includes a face of a human user. When the thermal image 112 includes only non-humans (such as animals) or other objects, the controller 150 can determine that the thermal image 112 does not contain any human users based on the comparison of the thermal image 112 and the defined thermal profile 154.

In one example, the controller 150 can determine, based on the thermal image 112, when the face of the user 170 is located within a selected range of distances from the thermal imager 110. More specifically, the controller 150 can use the facial analysis application 152 that executes on the biometric identification system 140 to determine, based on the thermal image 112, when the face of the user 170 is located within the selected range of distances from the thermal imager 110. For example, the facial analysis application 152 can be used to determine a distance between the user's face and the thermal imager 110 based on the thermal image 112, and whether the distance is within the selected range of distances. The selected range of distances can indicate acceptable distances between the user's face and the thermal imager 110. Similarly, the controller 150 can determine, based on the thermal image 112, when the face of the user 170 is not located within the selected range of distances from the thermal imager 110. In other words, the user's face can be located at a distance from the thermal imager 110 that is outside the selected range of distances (e.g., the user's face is either too close to the thermal imager 110 or too far from the thermal imager 110).

As a non-limiting example, the selected range of distances can be from 5 centimeters (cm) to 1 meter (m). In other words, in this non-limiting example, the controller 150 can determine, via the facial analysis application 152, when the face of the user 170 is located greater than 5 cm from the thermal imager 110 and less than 1 m from the thermal imager 110. Alternatively, in this non-limiting example, the controller 150 can determine, via the facial analysis application 152, when the face of the user 170 is located less than 5 cm from the thermal imager 110 or greater than 1 m from the thermal imager 110 (i.e., the distance between the face of the user 170 and the thermal imager 110 is not within the selected range of distances).

In one example, the controller 150 can provide a notification to the user 170 when the user 170 is located within the selected range of distances from the thermal imager 110. The notification can include video information, audio information and/or tactile information. Based on the notification, the user 170 can know when they are positioned at an acceptable distance from the thermal imager 110.

In one example, the controller 150 can instruct the IR illumination device 120 to illuminate for a selected period of time when the face of the user 170 is located within the selected range of distances from the thermal imager 110. More specifically, the IR illumination device 120 can illuminate the user's eye (or eyes) for the selected period of time. The IR illumination device 120 can illuminate only for the selected period of time when the thermal image 112 includes the face of the user 170 and the face of the user 170 is located within the selected range of distances from the thermal imager 110, which can minimize the user's exposure to radiation caused by the IR illumination device 120. In other words, when the face of the user 170 is not located within the selected range of distances from the thermal imager 110, the IR illumination device 120 may not turn on and unnecessarily expose the user 170 to radiation. As explained in further detail below, the IR illumination device 120 can be illuminated for the selected period of time to enable biometric identification to be performed for the user 170.

In one example, the eye scanning camera 130 can capture a biometric image 132 of the user's eye when illuminated by the IR illumination device 120 for the selected period of time, and the eye scanning camera 130 can capture the biometric image 132 of the user's eye when the face of the user 170 is located within the selected range of distances from the thermal imager 110. In this example, the eye scanning camera 130 and the thermal imager 110 can be located at substantially the same distance from the user 170. The eye scanning camera 130 can provide the biometric image 132 to an identity verification application 156 that executes on the biometric identification system 140. The controller 150 can compare, via the identity verification application 156, the biometric image 132 of the eye of the user 170 to stored biometric information 158. The biometric information 158 can be stored in the biometric identification system 140, or alternatively, the biometric information 158 can be stored externally but accessible to the biometric identification system 140. The biometric information 158 can include a plurality of biometric images of user eyes. The controller 150 can determine, via the identity verification application 156, that the biometric image 132 of the eye of the user 170 matches with a defined biometric image stored in the biometric information 158. The controller 150 can provide an indication to an external system 160 when the biometric image 132 of the eye of the user 170 matches with the defined biometric image in the biometric information 158, and the external system 160 can provide a defined type of access to the user 170 based on the indication.

In one configuration, the controller 150 can determine, via the identity verification application 156, that the biometric image 132 of the eye of the user 170 does not match with a defined biometric image stored in the biometric information 158. The controller 150 can provide an indication to an external system 160 when the biometric image 132 of the eye of the user 170 does not match with the defined biometric image in the biometric information 158, and the external system 160 may not provide a defined type of access to the user 170 based on the indication. In addition, when the biometric image 132 of the eye of the user 170 does not match with a defined biometric image stored in the biometric information 158, the controller 150 can provide such an indication to the user 170.

As a non-limiting example, the external system 160 can be a security system in a building or home. In this non-limiting example, the user 170 can walk up to the imaging device 100 (which can be installed in the building or home), and the thermal imager 110 can capture a thermal image 112 that contains the user 170. After verifying that the user 170 is within the selected range of distances from the thermal imager 110, the IR illumination device 120 can be instructed to illuminate for a selected period of time. When the IR illumination device 120 is illuminated, the eye scanning camera 130 can capture a biometric image 132 of the user 170. Based on the biometric image 132, the controller 150 can provide an indication to the security system that the user 170 is successfully identified and authenticated, and then the security system can permit the user 170 to enter the building or home. In other words, once the identity of the user 170 is verified by the controller 150, the security system can permit the user 170 to enter the building or home. Alternatively, when the user 170 is not successfully identified and authenticated based on the biometric image 132, the security system can prevent the user 170 from entering the building or home.

As another non-limiting example, the biometric identification system 140 and the imaging device 100 can be incorporated into a consumer device, such as a computer, laptop computer, tablet, or mobile phone. In this non-limiting example, when the consumer device is powered on or wakes up from a power saving mode, the thermal imager 110 can capture a thermal image 112 that contains the user 170. After verifying that the user 170 is within the selected range of distances from the thermal imager 110, the IR illumination device 120 can be instructed to illuminate for a selected period of time. When the IR illumination device 120 is illuminated, the eye scanning camera 130 can capture a biometric image 132 of the user 170. Based on the biometric image 132, the user 170 can be identified and authenticated, and then the user 170 can be permitted to use the consumer device. Alternatively, when the user 170 is not successfully identified and authenticated based on the biometric image 132, the user 170 can be prevented from using the consumer device.

As yet another non-limiting example, the external system 160 can be a home automation system. In this non-limiting example, the user 170 can attempt to access a control panel in the home automation system. The imaging device 100 can be installed in proximity to the control panel. The thermal imager 110 included in the imaging device 100 can capture a thermal image 112 that contains the user 170. After verifying that the user 170 is within the selected range of distances from the thermal imager 110, the IR illumination device 120 can be instructed to illuminate for a selected period of time. When the IR illumination device 120 is illuminated, the eye scanning camera 130 can capture a biometric image 132 of the user 170. Based on the biometric image 132, the controller 150 can provide an indication to the control panel that the user 170 is successfully identified and authenticated, and then the control panel can permit the user 170 to adjust settings, access information, etc. associated with the home automation system. In the case where the user has stored personalized settings information in the home automation system, the system may engage such settings automatically upon identification and authentication of the user. Alternatively, when the user 170 is not successfully identified and authenticated based on the biometric image 132, the control panel can prevent the user 170 from adjusting settings, accessing information, etc. associated with the home automation system.

In one configuration, the controller 150 can determine, based on the thermal image 112, that the face of the user 170 is not located within the selected range of distances from the thermal imager 110. In this case, the controller 150 can determine to not instruct the IR illumination device 120 to illuminate for the selected period of time. When the user 170 is not within the selected range of distances from the thermal imager 110 (e.g., the user 170 is too far away from the thermal imager 110 or too close to the thermal imager 110), a biometric image 132 captured of the user's face is unlikely to be successfully used for biometric identification (since the image quality of the user's eyes is likely to be poor). Therefore, in order to prevent the user 170 from being unnecessarily exposed to radiation, the IR illumination device 120 may not be instructed to illuminate when the user 170 is not within the selected range of distances from the thermal imager 110.

In one configuration, when the user 170 is not within the selected range of distances from the thermal imager 110 (as determined based on the thermal image 112), the user 170 can be notified to adjust a position such that the user 170 is within the selected range of distances from the thermal imager 110. For example, the notification can include video information, audio information and/or tactile information. Based on the notification, the user 170 can know when to adjust their position. In one example, the notification can include instructions for the user 170 to move towards the thermal imager 110 by a selected distance or to move away from the thermal imager 110 by a selected distance. The user 170 may be notified when the user 170 is located within the selected range of distances from the thermal imager 110.

In one configuration, when the user 170 is not within the selected range of distances from the thermal imager 110 (as determined based on the thermal image 112), the IR illumination device 120 can be disabled or turned off to conserve power. For example, the controller 150 can determine, based on the thermal image 112, that the user 170 is located at a distance that is outside the range of the eye scanning camera 130, such that any biometric images 132 captured by the eye scanning camera 130 would be poor quality and could not be used for biometric identification of the user 170. In this case, the controller 150 can turn off or temporarily disable the IR illumination device 120 to conserve power. In addition, the controller 150 can turn off or temporarily disable the eye scanning camera 130 to conserve power.

In one configuration, the use of the thermal imager 110 can ensure that a live user is positioned in front of the thermal imager 110 (and the eye scanning camera 130). An analysis of the thermal image 112 captured by the thermal imager 110 can reveal whether the object contained in the thermal image 112 is a live user (as opposed to an animal or a non-human object). The thermal image 112 can include distinct thermal patterns of a human face when the thermal image 112 includes a live user. Therefore, the usage of the thermal imager 110 can function as an anti-spoofing mechanism since the ability to take thermal images can potentially prevent spoofing attacks. Anti-spoofing is an important feature when the biometric identification system 140 is being used for biometric logins (e.g., identifying and/or authenticating users).

In addition, the usage of the thermal imager 110 is a key advantage to using a proximity sensor in the biometric identification system 140. While a proximity sensor may be used to determine whether an object is within the selected range of distances from the eye scanning camera 130, unlike the thermal imager 110, the proximity sensor would not enable the controller 150 to determine whether the object is a live human user. Therefore, the use of the thermal imager 110 can be advantageous over using a proximity sensor in the biometric identification system 140.

In one configuration, the IR illumination device 120 can only illuminate during an eye scanning process and when the user 170 is positioned at an appropriate distance from the thermal imager 110, which can minimize the amount of radiation to which the user 170 is exposed. In this configuration, the eye scanning camera 130 and the thermal imager 110 can be located at substantially the same distance from the user 170. The IR illumination device 120 may not illuminate (and thereby not radiate) when the user 170 is not positioned at an appropriate distance from the thermal imager 110 (and presumably the eye scanning camera 130). In one example, since the IR illumination device 120 can only operate during the eye scanning process, the power consumption can be reduced. Since the eye scanning camera 130 does not need to be turned on for prolonged duration while searching for the user's face, the IR illumination device 120 can illuminate for a reduced duration, thereby saving power. Similarly, the user 170 may only be exposed to the IR illumination device's radiation for a reduced duration, and not continuously when the eye scanning camera 130 is searching for the user's face. In one example, since the IR illumination device 120 can only illuminate for relatively brief periods of time, an operating temperature of the IR illumination device 120 can be kept within a reduced temperature range, which can improve the performance of the IR illumination device 120. In addition, field of view (FOV) specifications for a camera lens in the eye scanning camera 130 can be relaxed since the user 170 is located within a more precise range of distances from the thermal imager 110 and the eye scanning camera 130. The position of the user's face can be more precisely understood using the thermal image 112 of the user, as opposed to using a proximity sensor.

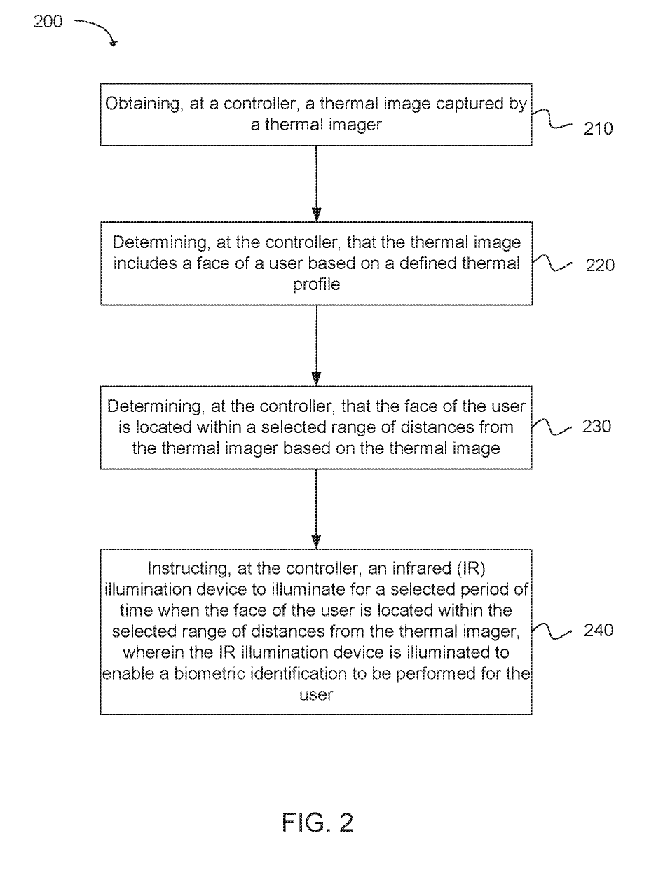

Another example provides a method 200 for identifying a user's biometrics, as shown in the flow chart in FIG. 2. The method can be executed as instructions on a machine, where the instructions are included on at least one computer readable medium or one non-transitory machine readable storage medium. The method can include the operation of: obtaining, at a controller, a thermal image captured by a thermal imager, as in block 210. The method can include the operation of: determining, at the controller, that the thermal image includes a face of a user based on a defined thermal profile, as in block 220. The method can include the operation of: determining, at the controller, that the face of the user is located within a selected range of distances from the thermal imager based on the thermal image, as in block 230. The method can include the operation of: instructing, at the controller, an infrared (IR) illumination device to illuminate for a selected period of time when the face of the user is located within the selected range of distances from the thermal imager, wherein the IR illumination device is illuminated to enable a biometric identification to be performed for the user, as in block 240.

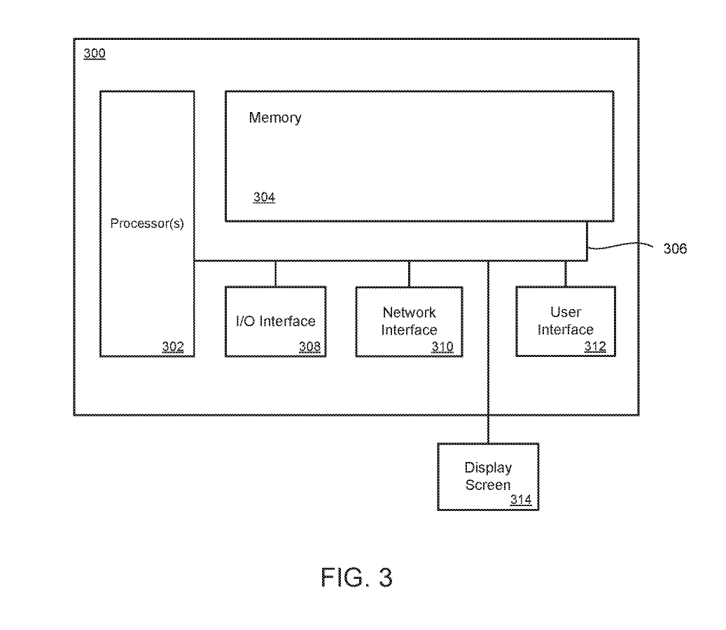

FIG. 3 illustrates a general computing system or device 300 that can be employed in the present technology. The computing system 300 can include a processor 302 in communication with a memory 304. The memory 304 can include any device, combination of devices, circuitry, and the like that is capable of storing, accessing, organizing and/or retrieving data. Non-limiting examples include SANs (Storage Area Network), cloud storage networks, volatile or non-volatile RAM, phase change memory, optical media, hard-drive type media, and the like, including combinations thereof.

The computing system or device 300 additionally includes a local communication interface 306 for connectivity between the various components of the system. For example, the local communication interface 306 can be a local data bus and/or any related address or control busses as may be desired.

The computing system or device 300 can also include an I/O (input/output) interface 308 for controlling the I/O functions of the system, as well as for I/O connectivity to devices outside of the computing system 300. A network interface 310 can also be included for network connectivity. The network interface 310 can control network communications both within the system and outside of the system. The network interface can include a wired interface, a wireless interface, a Bluetooth interface, optical interface, and the like, including appropriate combinations thereof. Furthermore, the computing system 300 can additionally include a user interface 312, a display device 314, as well as various other components that would be beneficial for such a system.

The processor 302 can be a single or multiple processors, and the memory 304 can be a single or multiple memories. The local communication interface 306 can be used as a pathway to facilitate communication between any of a single processor, multiple processors, a single memory, multiple memories, the various interfaces, and the like, in any useful combination.

Various techniques, or certain aspects or portions thereof, can take the form of program code (i.e., instructions) embodied in tangible media, such as floppy diskettes, CD-ROMs, hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a RAM, EPROM, flash drive, optical drive, magnetic hard drive, solid state drive, or other medium for storing electronic data. The node and wireless device can also include a transceiver module, a counter module, a processing module, and/or a clock module or timer module. One or more programs that can implement or utilize the various techniques described herein can use an application programming interface (API), reusable controls, and the like. Such programs can be implemented in a high level procedural or object oriented programming language to communicate with a computer system. However, the program(s) can be implemented in assembly or machine language, if desired. In any case, the language can be a compiled or interpreted language, and combined with hardware implementations. Exemplary systems or devices can include without limitation, laptop computers, tablet computers, desktop computers, smart phones, computer terminals and servers, storage databases, and other electronics which utilize circuitry and programmable memory, such as household appliances, smart televisions, digital video disc (DVD) players, heating, ventilating, and air conditioning (HVAC) controllers, light switches, and the like.

### EXAMPLES

The following examples pertain to specific invention embodiments and point out specific features, elements, or steps that can be used or otherwise combined in achieving such embodiments.

In one example there is provided a biometric identification system comprising:
an infrared (IR) illumination device;
a thermal imager; and
a controller comprising circuitry configured to:
   determine, using a defined thermal profile, when a thermal image captured by the thermal imager includes a face of a user;
   determine, based on the thermal image, when the face of the user is located within a selected range of distances from the thermal imager; and
   instruct the IR illumination device to illuminate for a selected period of time when the face of the user is located within the selected range of distances from the thermal imager.

In one example of a biometric identification system, the IR illumination device illuminates for the selected period of time to enable biometric identification to be performed for the user.

In one example of a biometric identification system, the IR illumination device includes an IR light emitting diode (LED) or an IR laser.

In one example of a biometric identification system, the controller further comprises circuitry configured to:
determine, based on the thermal image, that the face of the user is not located within the selected range of distances from the thermal imager; and
determine to not instruct the IR illumination device to illuminate for the selected period of time.

In one example of a biometric identification system, the controller further comprises circuitry configured to:
determine, based on the thermal image, that the face of the user is not located within the selected range of distances from the thermal imager; and
notify the user to adjust a position to be within the selected range of distances from the thermal imager.

In one example of a biometric identification system, the controller further comprises circuitry configured to provide a notification to the user when the user is not located within the selected range of distances from the thermal imager, wherein the notification includes at least one of video, audio or tactile information.

In one example of a biometric identification system, the controller further comprises circuitry configured to provide a notification to the user when the face of the user is located within the selected range of distances from the thermal imager, wherein the notification includes at least one of video, audio or tactile information.

In one example of a biometric identification system, the controller further comprises circuitry configured to:
determine, based on the thermal image, that the face of the user is not located within the selected range of distances from the thermal imager; and
disable the IR illumination device to conserve power.

In one example of a biometric identification system, the biometric identification system further comprises an eye scanning camera that is configured to capture a biometric image of an eye of the user when illuminated by the IR illumination device for the selected period of time.

In one example of a biometric identification system, the controller further comprises circuitry configured to:
compare the biometric image of the eye of the user to biometric information stored in a data store, wherein the biometric information includes a plurality of biometric images of user eyes;
determine that the biometric image of the eye of the user matches with a defined biometric image stored in the data store; and
provide an indication to an external system when the biometric image of the eye of the user matches with the defined biometric image in the data store, and the external system is configured to provide a defined type of access to the user based on the indication.

In one example of a biometric identification system, the controller further comprises circuitry configured to provide a notification to the user when the biometric image of the eye of the user does not match with biometric images stored in the data store.

In one example of a biometric identification system, the controller further comprises circuitry configured to disable the eye scanning camera when the face of the user is not located within the selected range of distances from the thermal imager.

In one example of a biometric identification system, the controller further comprises circuitry configured to determine that the thermal image includes the face of the user using a facial analysis application that executes on the biometric identification system.

In one example of a biometric identification system, the controller further comprises circuitry configured to determine when the face of the user is located within the selected range of distances from the thermal imager using a facial analysis application that executes on the biometric identification system.

In one example of a biometric identification system, the IR illumination device is configured to only illuminate for the selected period of time when the thermal image includes the face of the user and the face of the user is located within the selected range of distances from the thermal imager to minimize the user's exposure to radiation.

In one example of a biometric identification system, the controller further comprises circuitry configured to determine when the thermal image includes the face of the user based on a comparison between the thermal image and the defined thermal profile, wherein the defined thermal profile is specific to live human users.

In one example there is provided a device operable to identify user biometrics, the device comprising:
an infrared (IR) illumination device;
a thermal imager; and
a controller comprising one or more processors and memory configured to:
   obtain a thermal image captured by the thermal imager;
   determine, using a defined thermal profile, when the thermal image includes a face of a user;
   determine, based on the thermal image, when the face of the user is located within a selected range of distances from the thermal imager; and
   instruct the IR illumination device to illuminate for a selected period of time when the face of the user is located within the selected range of distances from the thermal imager, wherein the IR illumination device is illuminated to enable a biometric identification to be performed for the user.

In one example of a device, the IR illumination device includes an IR light emitting diode (LED) or an IR laser.

In one example of a device, the controller is further configured to:
determine, based on the thermal image, that the face of the user is not located within the selected range of distances from the thermal imager; and
determine to not instruct the IR illumination device to illuminate for the selected period of time.

In one example of a device, the controller is further configured to:
determine, based on the thermal image, that the face of the user is not located within the selected range of distances from the thermal imager; and
provide a message for display that notifies the user to adjust a position to be within the selected range of distances from the thermal imager.

In one example of a device, the controller is further configured to:
determine, based on the thermal image, that the face of the user is not located within the selected range of distances from the thermal imager; and
disable the IR illumination device to conserve power.

In one example of a device, the device further comprises an eye scanning camera configured to capture a biometric image of an eye of the user when illuminated by the IR illumination device for the selected period of time.

In one example of a device, the controller is configured to:
compare the biometric image of the eye of the user to biometric information stored in a data store, wherein the biometric information includes a plurality of biometric images of user eyes;
determine that the biometric image of the eye of the user matches with a defined biometric image stored in the data store; and
provide an indication to an external system when the biometric image of the eye of the user matches with the defined biometric image in the data store, and the external system is configured to provide a defined type of access to the user based on the indication.

In one example of a device, the controller is configured to execute a facial analysis application that determines when the thermal image includes the face of the user and when the face of the user is located within the selected range of distances from the thermal imager.

In one example of a device, the IR illumination device is configured to only illuminate for the selected period of time when the thermal image includes the face of the user and the face of the user is located within the selected range of distances from the thermal imager to minimize the user's exposure to radiation.

In one example of a device, the controller is configured to determine when the thermal image includes the face of the user based on a comparison between the thermal image and the defined thermal profile, wherein the defined thermal profile is specific to live human users.

In one example there is provided a method for identifying a user's biometrics, the method comprising:
obtaining, at a controller, a thermal image captured by a thermal imager;
determining, at the controller, that the thermal image includes a face of a user based on a defined thermal profile;
determining, at the controller, that the face of the user is located within a selected range of distances from the thermal imager based on the thermal image; and
instructing, at the controller, an infrared (IR) illumination device to illuminate for a selected period of time when the face of the user is located within the selected range of distances from the thermal imager, wherein the IR illumination device is illuminated to enable a biometric identification to be performed for the user.

In one example of a method for identifying a user's biometrics, the method further comprises determining that the thermal image includes the face of the user using a facial analysis application.

In one example of a method for identifying a user's biometrics, the method further comprises determining that the face of the user is located within the selected range of distances from the thermal imager using a facial analysis application.

In one example of a method for identifying a user's biometrics, the method further comprises determining that the thermal image includes the face of the user based on a comparison between the thermal image and the defined thermal profile, wherein the defined thermal profile is specific to live human users.

In one example of a method for identifying a user's biometrics, the method further comprises instructing the IR illumination device to illuminate for the selected period of time only after determining that the thermal image includes the face of the user and the face of the user is located within the selected range of distances from the thermal imager to minimize a level of radiation exposed by the user.

In one example of a method for identifying a user's biometrics, the method further comprises:
obtaining a biometric image of an eye of the user captured when the eye is illuminated by the IR illumination device for the selected period of time;
comparing the biometric image of the eye of the user to biometric information stored in a data store, wherein the biometric information includes a plurality of biometric images of user eyes;
determining that the biometric image of the eye of the user matches with a defined biometric image stored in the data store; and
providing an indication to an external system when the biometric image of the eye of the user matches with the defined biometric image in the data store, and the external system is configured to provide a defined type of access to the user based on the indication.

While the forgoing examples are illustrative of the principles of invention embodiments in one or more particular applications, it will be apparent to those of ordinary skill in the art that numerous modifications in form, usage and details of implementation can be made without the exercise of inventive faculty, and without departing from the principles and concepts of the disclosure.

What is claimed is:

1. A biometric identification system comprising:
an infrared (IR) illumination device;
a thermal imager; and
a controller comprising circuitry configured to:
determine, using a defined thermal profile, when a thermal image captured by the thermal imager includes a face of a user;
determine, based on the thermal image, when the face of the user is located within a selected range of distances from the thermal imager; and
instruct the IR illumination device to illuminate for a selected period of time when the face of the user is located within the selected range of distances from the thermal imager.

2. The biometric identification system of claim 1, wherein the IR illumination device illuminates for the selected period of time to allow biometric identification to be performed for the user.

3. The biometric identification system of claim 1, wherein the IR illumination device includes an IR light emitting diode (LED) or an IR laser.

4. The biometric identification system of claim 1, wherein the controller further comprises circuitry configured to:
determine, based on the thermal image, that the face of the user is not located within the selected range of distances from the thermal imager; and
determine to not instruct the IR illumination device to illuminate for the selected period of time.

5. The biometric identification system of claim 1, wherein the controller further comprises circuitry configured to:
determine, based on the thermal image, that the face of the user is not located within the selected range of distances from the thermal imager; and
notify the user to adjust a position to be within the selected range of distances from the thermal imager.

6. The biometric identification system of claim 5, wherein the controller further comprises circuitry configured to provide a notification to the user when the user is not located within the selected range of distances from the thermal imager, wherein the notification includes at least one of video, audio or tactile information.

7. The biometric identification system of claim 1, wherein the controller further comprises circuitry configured to provide a notification to the user when the face of the user is located within the selected range of distances from the thermal imager, wherein the notification includes at least one of video, audio or tactile information.

8. The biometric identification system of claim 1, wherein the controller further comprises circuitry configured to:
determine, based on the thermal image, that the face of the user is not located within the selected range of distances from the thermal imager; and
disable the IR illumination device to conserve power.

9. The biometric identification system of claim 1, further comprising an eye scanning camera that is configured to capture a biometric image of an eye of the user when illuminated by the IR illumination device for the selected period of time.

10. The biometric identification system of claim 9, wherein the controller further comprises circuitry configured to:
compare the biometric image of the eye of the user to biometric information stored in a data store, wherein the biometric information includes a plurality of biometric images of user eyes;
determine that the biometric image of the eye of the user matches with a defined biometric image stored in the data store; and
provide an indication to an external system when the biometric image of the eye of the user matches with the defined biometric image in the data store, and the external system is configured to provide a defined type of access to the user based on the indication.

11. The biometric identification system of claim 9, wherein the controller further comprises circuitry configured to provide a notification to the user when the biometric image of the eye of the user does not match with biometric images stored in the data store.

12. The biometric identification system of claim 9, wherein the controller further comprises circuitry configured to disable the eye scanning camera when the face of the user is not located within the selected range of distances from the thermal imager.

13. The biometric identification system of claim 1, wherein the controller further comprises circuitry configured to determine that the thermal image includes the face of the user using a facial analysis application that executes on the biometric identification system.

14. The biometric identification system of claim 1, wherein the controller further comprises circuitry configured to determine when the face of the user is located within the selected range of distances from the thermal imager using a facial analysis application that executes on the biometric identification system.

15. The biometric identification system of claim 1, wherein the IR illumination device is configured to only illuminate for the selected period of time when the thermal image includes the face of the user and the face of the user is located within the selected range of distances from the thermal imager to minimize the user's exposure to radiation.

16. The biometric identification system of claim 1, wherein the controller further comprises circuitry configured to determine when the thermal image includes the face of the user based on a comparison between the thermal image and the defined thermal profile, wherein the defined thermal profile is specific to live human users.

17. A method for identifying a user's biometrics, comprising:
obtaining, at a controller, a thermal image captured by a thermal imager;
determining, at the controller, that the thermal image includes a face of a user based on a defined thermal profile;
determining, at the controller, that the face of the user is located within a selected range of distances from the thermal imager based on the thermal image; and
instructing, at the controller, an infrared (IR) illumination device to illuminate for a selected period of time when the face of the user is located within the selected range of distances from the thermal imager, wherein the IR illumination device is illuminated to enable a biometric identification to be performed for the user.

18. The method of claim 17, further comprising determining that the thermal image includes the face of the user using a facial analysis application.

19. The method of claim 17, further comprising determining that the face of the user is located within the selected range of distances from the thermal imager using a facial analysis application.

20. The method of claim 17, further comprising determining that the thermal image includes the face of the user based on a comparison between the thermal image and the defined thermal profile, wherein the defined thermal profile is specific to live human users.

21. The method of claim 17, further comprising instructing the IR illumination device to illuminate for the selected period of time only after determining that the thermal image includes the face of the user and the face of the user is located within the selected range of distances from the thermal imager to minimize a level of radiation exposed by the user.

22. The method of claim 17, further comprising:
obtaining a biometric image of an eye of the user captured when the eye is illuminated by the IR illumination device for the selected period of time;
comparing the biometric image of the eye of the user to biometric information stored in a data store, wherein the biometric information includes a plurality of biometric images of user eyes;
determining that the biometric image of the eye of the user matches with a defined biometric image stored in the data store; and
providing an indication to an external system when the biometric image of the eye of the user matches with the defined biometric image in the data store, and the external system is configured to provide a defined type of access to the user based on the indication.
